(19) United States
(12) Patent Application Publication
(10) Pub. No.: US 2022/0057769 A1
(43) Pub. Date: Feb. 24, 2022

(54) PROGRAMMABLE MICROGRID CONTROL SYSTEM

(71) Applicant: OPERATION TECHNOLOGY, INC., Irvine, CA (US)

(72) Inventors: Mohammad Reza Dadash Zadeh, Irvine, CA (US); Fabian M. Uriarte, Irvine, CA (US)

(21) Appl. No.: 17/466,763

(22) Filed: Sep. 3, 2021

Related U.S. Application Data
(63) Continuation of application No. PCT/US20/21032, filed on Mar. 4, 2020.
(60) Provisional application No. 62/813,570, filed on Mar. 4, 2019.

(51) Int. Cl. G05B 19/05; G06F 30/33

(52) U.S. Cl. CPC G05B 19/054; G06F 2113/04; G06F 30/33

(57) ABSTRACT

Provided herein are embodiments of a programmable microgrid control system that includes programming software tools capable of modeling, analyzing and monitoring power system especially AC, DC and hybrid microgrids. The monitoring feature of the software tool allows tools to communicate with a real system to acquire online data of power system assets such as conventional and renewable energy sources, transformers, and electrical loads.

### CROSS-REFERENCE TO RELATED APPLICATIONS

This application is a continuation of International Patent Application No. PCT/US2020/021032, filed Mar. 4, 2020, which claims priority pursuant to U.S.C § 119(e) to U.S. Provisional Patent Application No. 62/813,570, filed Mar. 4, 2019, the disclosures of both of which are hereby incorporated by reference in their entireties for all purposes.

### FIELD

The subject matter described herein relates generally to systems, devices, and methods for a programmable microgrid control system including a programmable microgrid controller and its programming software tool.

### BACKGROUND

Microgrid is defined as a cluster of interconnected Distributed Generations (DGs), loads and Energy Storage Systems (ESSs) that can operate in grid-connected and islanded modes. Compared to a single DG, the microgrid can provide more technical benefits, control flexibilities, economical operation as well as better means of improving energy efficiency. Utilization of ESSs, Combined Heat, and Power (CHP) units, dispatchable loads and electric vehicles have recently created the extensive potential for new concepts of power system control and operation. Since all these devices are dispatchable, they require a control system to determine the dispatchable quantities based on various possible objectives and constraints.

Thus, needs exist for a programmable microgrid control system and method including a programmable microgrid controller and its programming software tool without currently known and unknown disadvantages. Furthermore, the new system and method also allow new energy resources to be employed to make microgrid operation possible in the islanded mode.

### SUMMARY

Provided herein are example embodiments of systems, devices and methods for a programmable microgrid control system including a programmable microgrid controller and its programming software tool. In some embodiments, the microgrid controller is an industrial computing and communicating device that runs an application capable of, among others: 1—executing control functions developed and tested by programming software tool and 2—data communication with microgrid assets such as DGs, ESSs and loads. Data communication settings such as IP addresses, protocols, and data address are all setup up by the programming software tool.

In some embodiments, the present disclosure may include a programmable microgrid control system for a microgrid power system, comprising: a programmable microgrid controller device deployed in the microgrid power system; a processor comprising a plurality of programming software tools configured to: generate a model of the microgrid power system, analyze performance of the model of the microgrid power system, generate a controller logic based on the model of the microgrid power system, transmit the controller logic to the programmable microgrid controller device, and monitor the microgrid power system; and wherein the programmable microgrid controller is configured to execute the controller logic, and communicate with one or more microgrid assets.

Other features and advantages of the present invention are or will become apparent to one skilled in the art upon examination of the following figures and detailed description, which illustrate, by way of examples, the principles of the present invention.

The systems, methods, and apparatuses for authoring content for use in programmable microgrid control system described herein in detail are only example embodiments and should not be considered limiting. Other configurations, methods, features and advantages of the subject matter described herein will be or will become apparent to one with skill in the art upon examination of the following figures and detailed description. It is intended that all such additional configurations, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 illustrates an exemplary high-level block diagram of an exemplary network, according to some embodiments of the present disclosure.

FIG. 2 illustrates exemplary main components of a programmable microgrid controller and its controller programming software tool, according to some embodiments of the present disclosure.

FIG. 3 illustrates exemplary detail of a microgrid controller model and development tool components and interactions, according to some embodiments of the present disclosure.

FIG. 4 illustrates an exemplary high-level diagram of a process of a cycle of user interaction to program, test and deploy a programmed microgrid controller, according to some embodiments of the present disclosure.

FIG. 5 illustrates an exemplary high-level diagram of more exemplary components of a programmable microgrid control system, according to some embodiments of the present disclosure.

FIG. 6 illustrates an exemplary overall platform in which various embodiments and process steps disclosed herein can be implemented, according to some embodiments of the present disclosure.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Microgrid control strategy generally heavily depends on microgrid assets, network topology, operation conventions, and reliability requirements. To implement microgrid control strategies, one approach is to program a controller fully or partially to meet microgrid requirements. This approach offers considerable flexibility to achieve desired control functionalities. Controller functionality should be extensively tested for each microgrid. Some current approaches of devising control logic and testing them involve a higher level of complexity and require extensive expert engineering effort. In some embodiments, the present disclosure provides systems, devices and methods for technical improvements in significantly simplifying the process of development and testing of microgrid control logic/function and making Programmable Microgrid Control System a very viable commercial solution and practical application.

As used herein, the term “microgrid” may include a portion of electric network such as a distribution feeder, a single electric load or generation, or a larger power system. A microgrid control system may be centralized or decentralized, which means that the control functionality may be implemented in one or several microgrid controllers. Also as used herein, a reference to a single microgrid controller may be applied to multiple microgrid controllers. In this disclosure, the terms “control logic” and “control function” are used interchangeably, and the terms “microgrid assets” and “microgrid controller” associated devices are also used interchangeably.

In some embodiments, a programmable microgrid control system (may also be referred to simply as the control system or system) of the present disclosure may include programming software tools for modeling, analyzing and monitoring power system especially AC, DC and hybrid microgrids. The monitoring feature of the software tools may allow tools to communicate with a real system to acquire online data of power system assets such as conventional and renewable energy sources, transformers, and electrical loads. The disclosed software tools provide a unique environment for modeling and evaluating the microgrid and its control system effectively and efficiently. In some embodiments, the control system may be modeled through one or multiple controller elements. The programming software tool may provide both graphical user interface and script-based development environment where a user can program and test microgrid controller logic. In some exemplary implementations, the script-based development environment may be preset Microsoft Visual Studio C # or C++ solution generated by microgrid programming software to enable intuitive coding environment as well as debugging capability. It should be noted that other software development environment may be used to achieve the same objectives of the present disclosure.

In some embodiments, the script-based development environment may be built based on a software development framework for power system applications where an engineer can easily access each power system element including its settings, connectivity information, inputs, and outputs to develop a control logic.

In some embodiments, the system may include basic and advanced power system analysis tools such as time-domain load flow, short circuit and transient stability studies for a given microgrid. These tools may allow a user to evaluate the performance of the programmed controller logic. In addition, a microgrid controller can utilize the programming software tool capabilities during operation in the field to perform basic and advanced power system analyses and utilize their results as part of the control logic. In this scenario, the programming software tool may employ real-time data to tune or verify the power system model under control to simulate real-time situation. All microgrid controller inputs and outputs may be recorded in a file during performance evaluation for further testing and debugging.

In some embodiments, the control system may include tester program, e.g., as part of the Visual Studio C # or C++ solution generated by microgrid controller software tool, to playback inputs recorded during simulation and performance evaluation while user can place several breakpoints within the code to observe the variables and find issues if any. In addition, user may attach the Visual Studio C # or C++ solution to programming software tool during analysis in debug mode for closed-loop testing and debugging.

When the user is satisfied with evaluation and testing in a software environment, the controller logic, and all the required settings may be transferred to the controller hardware. The disclosed controller is then capable of running the control logic and communicating with microgrid assets seamlessly without any extra effort.

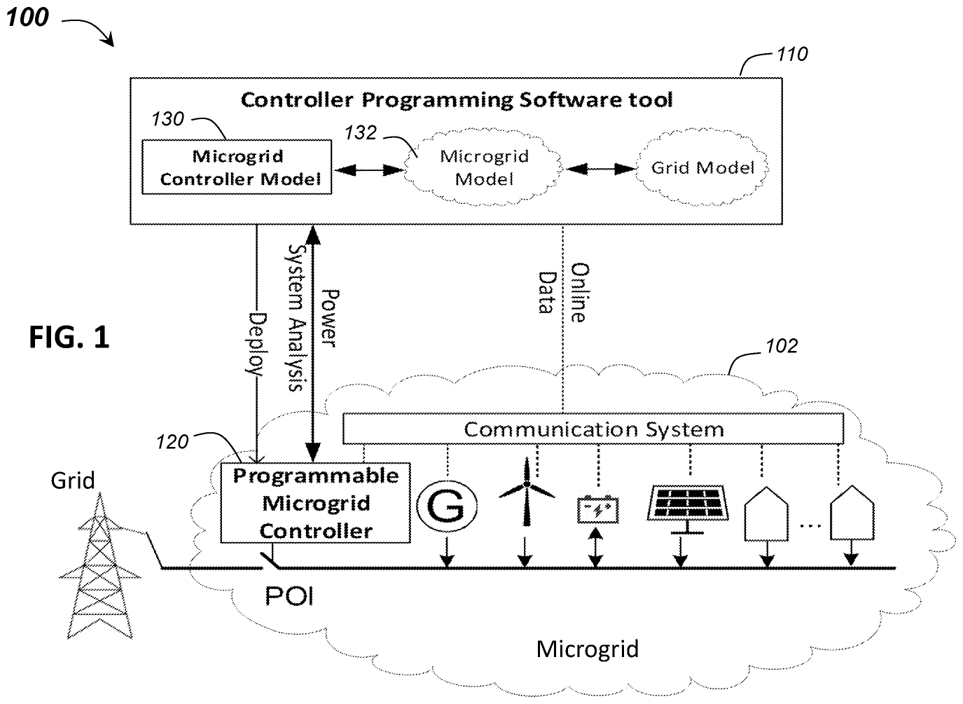

Turning now to the figures, as shown in FIG. 1, according to some embodiments of the present disclosure, a high-level block diagram of an exemplary network 100 of the present disclosure may include two main components: (1) Controller Programming Software Tool 110 and (2) Programmable Microgrid Controller 120 located or installed in microgrid 102. In some embodiments, a programmable microgrid controller 120 may be an industrial computing and communicating device that runs an application capable of, among others: (1) executing control functions developed and tested by controller programming software tool 110 and (2) data communication with microgrid assets such as DGs, ESSs and loads. The controller programming software tool 110 may be remote from the microgrid 102.

As used herein, tools may include software, hardware or a combination thereof.

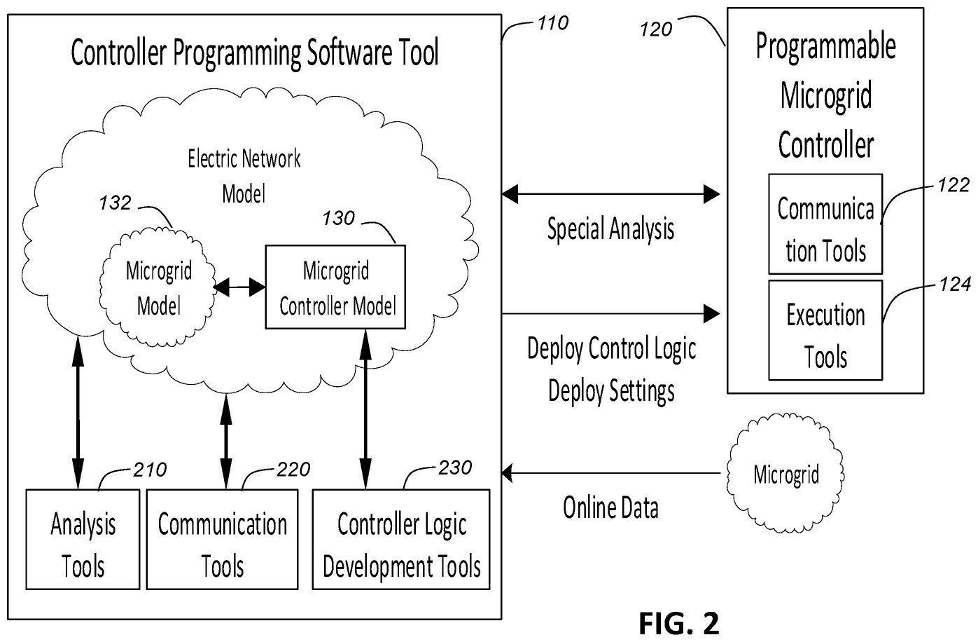

FIG. 2 shows exemplary main components of the Programmable Microgrid Controller 120 and its Controller Programming Software Tool 110, according to some embodiments of the present disclosure.

### Controller Programming Software Tool

In some embodiments, the Controller Programming Software Tool 110 may include at least the following:

1. Tool(s) 110 to model and analyze power system, especially AC, DC and hybrid AC and DC microgrids. The supported analysis types could be any of the basic studies such as time-domain load flow, short circuit, dynamic and electromagnetic transient studies as well as advanced studies, such as economic dispatch, protection, and coordination. The analysis tools may further simulate programmable microgrid controller behavior through a model embed in an element containing several user interfaces as explained below.

2. An element/model 130 to represent the microgrid controller (e.g., microgrid controller 120) that interacts with microgrid 132 assets within the simulation environment while it is a true replica of the actual microgrid controller 120 that will be used in real microgrid system 102. Further details are provided below (see, for example, section Microgrid Controller Model and Controller Logic Development Tools).

3. Controller logic development tool(s) 230 to develop microgrid control logics as detailed further below (see, for example, section Microgrid Controller Model and Controller Logic Development Tools).

4. Communication tool(s) 220 to communicate with microgrid assets including: (i) user interface to define communication settings, such as IP address, protocol type, and data addresses; and (ii) drivers or communication clients to read microgrid asset measurements and write their controlling set-points.

### Programmable Microgrid Controller

In some embodiments, the Programmable Microgrid Controller 120 may be an industrial computing and communicating device that executes tasks in a deterministic fashion. In some embodiments, the Programmable Microgrid Controller 120 may include at least the following.

1. Communication tool(s) 122 to communicate with microgrid assets, such as drivers to communicate with different protocols such as Modbus, DNP3, IEC 61850, as well as a communication client to schedule periodic read and write of required analog and digital data using the aforementioned drivers. In some embodiments, the communication settings may be provided by the Controller Programming Software Tool 110. Further, the Programmable Microgrid Controller 120 may communicate with the Controller Programming Software Tool 110 to receive new Control logic, settings, and also request performing basic or advanced analyses and receive their results and thereby making control decision.

2. Execution tool(s) 124 to execute tasks programmed through the Controller Programming Software Tool 110. In some embodiments, the execution may be in time intervals, which may be programmed by a user. In addition, the controller may include an interface with communication tool(s) to (i) acquire required data for tasks that are being executed, and (ii) transfer their controlling commands to communication tool(s) to be dispatched to microgrid assets.

### Microgrid Controller Model and Controller Logic Development Tools

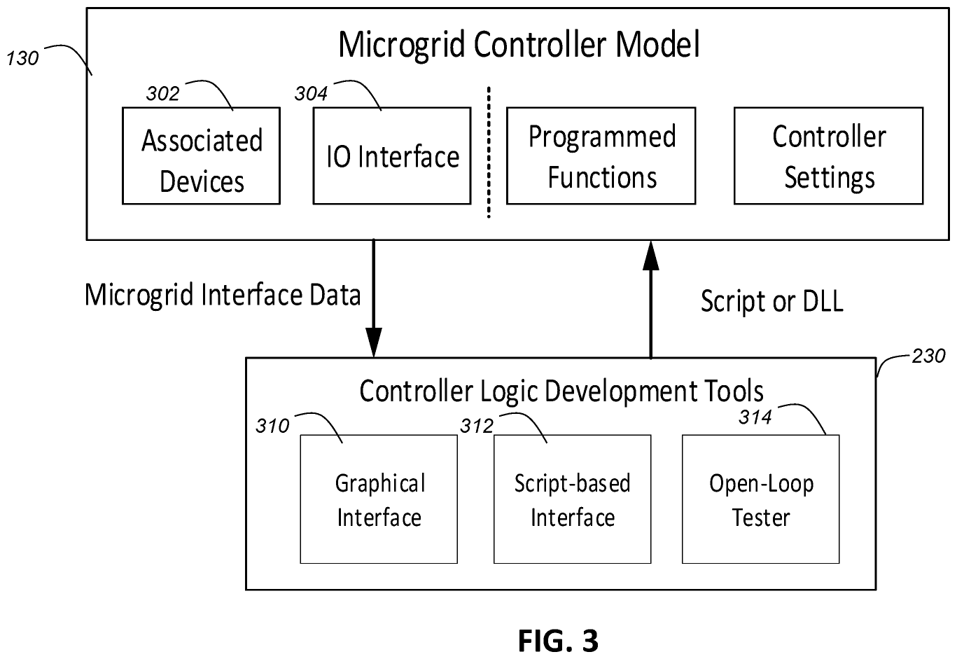

FIG. 3 shows further exemplary detail of the Microgrid Controller Model 130 and Development Tool 230 components and interactions, according to some embodiments of the present disclosure.

In some embodiments, the microgrid controller model 130 may have at least four components which can be described as follows.

1. A user interface where microgrid assets associated with the microgrid controller may be defined. This user interface may also be responsible for acquiring the higher-level settings that describe the level of interaction of the controller with the microgrid assets (e.g., if the asset is monitored, controlled, and how much the expected communication delay is).

2. A user interface where a user may define outgoing data to other controllers. This may be required for the process of automatic data interface generation for communication with other controllers, as a controller is a programmable device as compared to other microgrid assets such as generation or load where their input/output data are known by the controller programming software tool 110.

3. A user interface where a user may assign programmed functions or logic, for example in the form of a dynamic link library (DLL), that is generated by Controller Logic Development Tool(s) 230.

4. A user interface that shows the controller settings that are supposed to be input by a user.

As shown in FIG. 3, Controller Programming Software Tool 110 (see FIGS. 1 and 2) may utilize data related to Associated Devices 302, for example their type, parameters, possible monitoring and controlling, and Controller IO interface 304 to initialize the Controller Logic Development Tool(s) 230 where the user has an intuitive access either through script environment 312 or a graphical user interface 310 to the aforementioned data to setup/program desired control logic(s). The script-based development environment may be built based on a software development framework for power system applications where an engineer can easily access each power system element including its settings, connectivity information, inputs, and outputs to develop a control logic. Furthermore, the Controller Logic Development Tool(s) 230 may provide an interface to request performing power system analysis studies and receive results related to microgrid controller associated devices. These results may be used as part of the control logic in the present or future times.

As discussed above, all the interactions of the microgrid controller model during simulation may be recorded, for example in a file. This file can later be used by the Controller Logic Development Tool(s) 230 to perform tests, for example Open-loop test. In some embodiments, an Open-loop tester tool 314 may provide the ability for user to apply breakpoints within the script-based interface and monitor any variable value while the recorded data from the simulation is played back by the Open-Loop Tester tool 314. The Open-loop tester tool may also allow user to edit the recorded data for further testing and debugging. In addition, user may attach the Visual Studio C # or C++ solution to controller programming software tool 110 during analysis in debug mode for closed-loop testing and debugging. In some embodiments, Microgrid Controller Model 130 may import the programmed control logic through either a C # or C++ script or Dynamic-link Library (DLL) developed by the Controller Logic Development Tool(s) 230.

In some embodiments, during a simulation run time, monitoring data related to controller associated devices may be passed to the controller model. In some embodiments, controller tasks implemented in DLL through C # or C++ script may be executed based on their time interval and priority. Finally, control set-points and status commands resulted from executing tasks may be passed to microgrid controller associated devices to control the microgrid as programmed by a user. All the interactions between the microgrid controller and its associated devices and all interim variables within control functions if marked may be recorded for debugging and troubleshooting purpose.

In some embodiments, once satisfied with the controller model performance, the control logic, stored setting file and all communication settings to read/write date from/to microgrid assets that are set-up by a user for monitoring purpose and controlling data points are transferred by Controller Programming Software Tool 110 to the controller hardware 120. Using the aforementioned data, the disclosed microgrid controller 120 can run the control logic and communicate with microgrid assets seamlessly without any additional user intervention.

### User Interaction Process

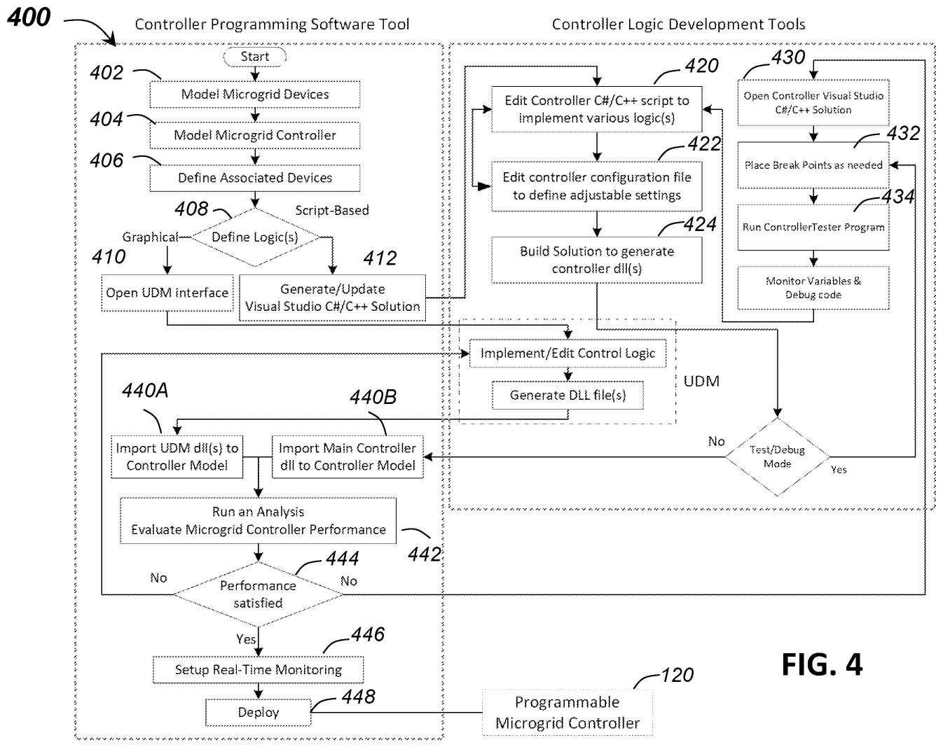

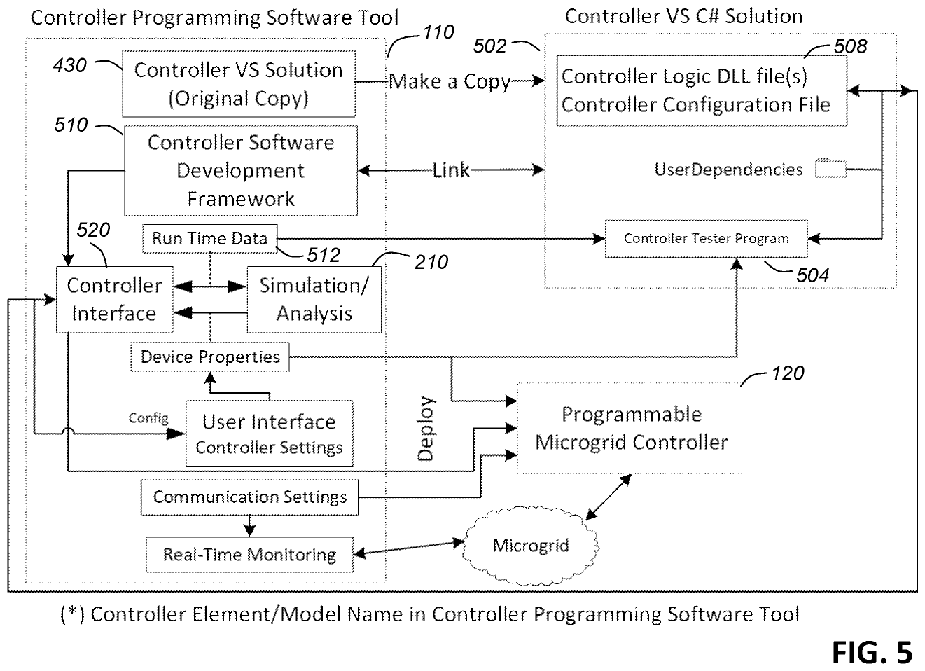

FIG. 4 shows an exemplary process 400 of a cycle of user interaction to program, test and deploy a programmed microgrid controller. In some embodiments, the process 400 may include at least the following steps.
1. At Step 402, a model of microgrid devices may be generated using the controller programming software tool 110 including energy sources, loads, storage and the network that connects them.
2. At Step 404, microgrid controller may be modeled using the controller programming software tool disclosed in the present disclosure. The following sub-steps are taken.
   A. At 406, within controller programing software tool 110, modeled microgrid devices such as energy sources, storage and loads that are associated in any level with the microgrid controller may be associated with microgrid controller model. Further, the level of association whether monitored, controlled or none may be set. All monitored microgrid devices and their monitoring data points may be input to the microgrid controller while controlled devices and their controlling data points are output of the microgrid controller.
   B. At 408, Microgrid controller logic may be defined using either graphical interface 410, or script-based tool 412.
      i. Use graphical interface (e.g., user-defined model (UDM)) to define various logics linking inputs, outputs and parameters. For each logic, compile and generate DLL file. Assign the execution rate for each logic DLL file.
      ii. Use Script-based tool to define the logic between inputs, outputs and controller/microgrid device settings.
         a. Generate/Update a Visual Studio C # or C++ Solution
         b. Open the solution and edit controller C # or C++ script 420 to define multiple tasks implementing various logics between inputs and outputs. Define tasks to execute in series or parallel as desired.
         c. Within the same C # or C++ solution, Open controller setting configuration file 422 and edit the file as instructed in the template to define any user setting required by the Microgrid Controller. An example of such setting is the limit of power export to the utility. It may be possible to go back and forth between this step and Step b several times to link controller user settings and controller logic.
         d. If additional files or DLLs are required to make controller script 420 functional, these files may be stored in a dedicated folder (shown as “UserDependencies” in FIG. 5 within 502) folder within the solution.
         e. Build Solution to generate controller dll file(s) 424.
      iii. At either Step 440A or 440B, the main DLL file may be imported to the controller model in the Controller Programming Software Tool.
      iv. Enter values for user-defined settings within the user interface of microgrid controller model provided by controller programming software tool.
3. At Step 442, the user may invoke the controller programming software tool to run an analysis such as time-domain load flow or transient stability to evaluate the performance of the programmed microgrid controller. User may attach the Visual Studio C # or C++ solution to the programming software tool 110 during analysis in debug mode for closed-loop testing and debugging. In case of script-based logic, if logic encounters an exception, for example division by zero or access to a memory location that does not exist, the Controller Programming Software Tool may stop the analysis and all the microgrid controller inputs and outputs for the entire simulation time interval will be recorded in a file for testing. If no exception is encountered but response is not as desired, the testing file may still be created for further testing.
   A. At Step 444, if an additional testing is required, may proceed as following.
      i. Open Visual Studio C # or C++ solution, at 432, place breakpoints at any desired location within controller main C # or C++ file or any additional file added by user.
      ii. In case of close-loop testing, once Controller Programming Software Tool is invoked by the user to run analysis, the analysis automatically pauses at the breakpoint where user can troubleshoot and evaluate the control logic. In case of open-loop testing, tester project (e.g., shown as Controller Tester Program 434) may be invoked by user to playback data to the control logic inputs and monitor and analysis variables at any location.
      iii. Once issues are found and fixed, proceed to Step 446e.
   B. Back to Step 444, if no additional testing required, go to the next step (Step 446).
4. At Step 446, set up microgrid system for real time monitoring. This may mainly include defining required communication settings for microgrid devices to be able to read and write required data. Go online using Controller Programming Software Tool to connect to microgrid assets. Verify that all the required data can be communicated. The testing of communication interface can be done in a laboratory environment using a real-time simulator or in the field.
5. At Step 448, user may invoke Controller Programming Software Tool to deploy the Controller model to the Microgrid controller hardware 120. The dll file(s) may be encrypted and stored in the microgrid controller hardware. The Microgrid Controller 120 decrypts the encrypted dll file(s) within memory to protect any intellectual property if needed.

### Implementation to Achieve Intuitive, Testable and Debug-Able Script-Based Environment

FIG. 5 shows a high-level diagram of more exemplary components of the Programmable Microgrid Control System. As shown in FIG. 5, the Controller Programming Software Tool 110 may maintain an original copy of preset Controller Visual Studio C # or C++ solution (also shown as 430 in FIG. 4) to clone a new user defined location 502 as needed. In addition, the Controller Programming Software Tool 110 may include a software development framework in forms of one or multiple dll files 510 that provide supporting objects and methods to make Controller VS Solution 502 functional as well as intuitive to use.

In some embodiments, once user control logic 508 is generated, upon importing the dll file(s), Controller Programming Software Tool 110 may import controller configuration file to update Controller user interface to display and acquire controller user set-points 522. It may also perform health check of the dll file(s).

In some embodiments, once any analysis is initiated by the user, device properties of controller associated devices, for example ratings, fuel costs, efficiencies as well as controller properties itself, for example the values assigned by user for the controller user settings, are passed, by the Controller Programming Software Tool 110, to Controller Interface 520 to initialize controller model 130. At each step of simulation, all required data by the controller model such as voltage and power will be collected from the simulation and passed to Controller model 130 by Controller Programming Software Tool 110 though Controller Interface 520. Then, Programmable Microgrid Controller 120 will execute a one-time step determining all the control commands such as power reference that need to be transferred to the simulation updating the device operating set-points. The process continues till the end of simulation time. All the data exchange between the controller model and analysis tools (shown as 210 in FIG. 2) is shown as Run Time Data 512 in the FIG. 5. In some embodiments, user may attach the Controller Visual Studio C # or C++ solution 502 to controller programming software tool 110 during analysis in debug mode for monitoring all control logic variables and detailed testing and debugging.

In some embodiments, once simulation is completed or stopped due to an exception in the controller execution, the Run Time Data and Device Properties may be recorded into file(s). The user may now utilize these file(s) within controller tester program 504 to test and debug Controller C # or C++ scripts 502. Controller Tester Program 504 may initialize the Controller and playback the recorded data. The user can easily place breakpoints in anywhere in the code to monitor variables and debug the controller logic.

In some embodiments, once satisfied with the controller logic, the user may setup real time monitoring for the microgrid within Controller Programming Software Tool 110. All the communication settings may be stored in a file. In some embodiments, once satisfied with data monitoring, files will be transferred to deploy the logic into the Microgrid Controller. The files may include: 1—Device Properties and controller configuration file, 2—DLL file(s), 3-Communication setting files.

### System Architecture

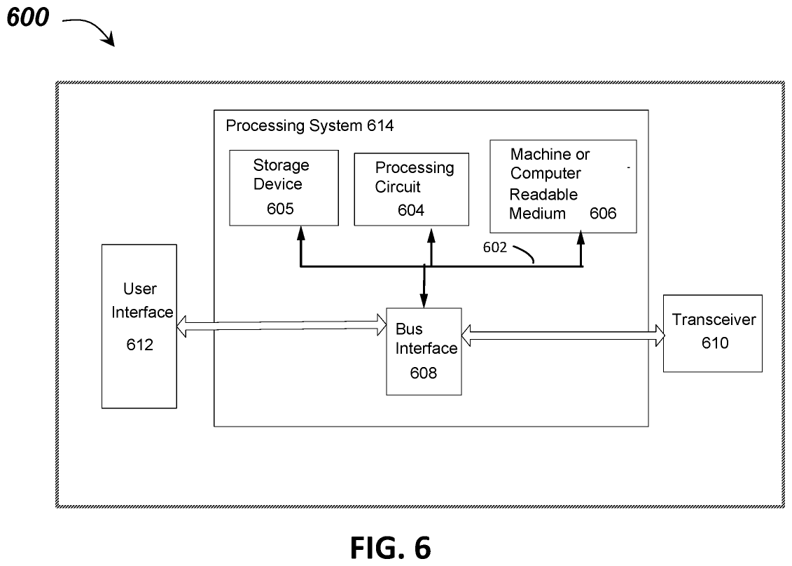

FIG. 6 illustrates an exemplary overall platform 600 in which various embodiments and process steps disclosed herein can be implemented. In accordance with various aspects of the disclosure, an element, or any portion of an element, or any combination of elements may be implemented with a processing system 614 that includes one or more processing circuits 604. Processing circuits 604 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 604 may be used to implement any one or more of the various embodiments, systems, algorithms, and processes described above. In some embodiments, the processing system 614 may be implemented in a server. The server may be local or remote, for example in a cloud architecture.

In the example of FIG. 6, the processing system 614 may be implemented with a bus architecture, represented generally by the bus 602. The bus 602 may include any number of interconnecting buses and bridges depending on the specific application of the processing system 614 and the overall design constraints. The bus 602 may link various circuits including one or more processing circuits (represented generally by the processing circuit 604), the storage device 605, and a machine-readable, processor-readable, processing circuit-readable or computer-readable media (represented generally by a non-transitory machine-readable medium 609). The bus 602 may also link various other circuits such as timing sources, peripherals, voltage regulators, and power management circuits, which are well known in the art, and therefore, will not be described any further. The bus interface 608 may provide an interface between bus 602 and a transceiver 613. The transceiver 610 may provide a means for communicating with various other apparatus over a transmission medium. Depending upon the nature of the apparatus, a user interface 612 (e.g., keypad, display, speaker, microphone, touchscreen, motion sensor) may also be provided.

The processing circuit 604 may be responsible for managing the bus 602 and for general processing, including the execution of software stored on the machine-readable medium 606. The software, when executed by processing circuit 604, causes processing system 614 to perform the various functions described herein for any particular apparatus. Machine-readable medium 606 may also be used for storing data that is manipulated by processing circuit 604 when executing software.

One or more processing circuits 604 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

1. A programmable microgrid control system for a microgrid power system, comprising:
a programmable microgrid controller device deployed in the microgrid power system;
a processor comprising a plurality of programming software tools configured to:
generate a model of the microgrid power system,
analyze performance of the model of the microgrid power system,
generate a controller logic based on the model of the microgrid power system,
transmit the controller logic to the programmable microgrid controller device, and
monitor the microgrid power system; and
wherein the programmable microgrid controller is configured to execute the controller logic, and communicate with one or more microgrid assets.

2. The programmable microgrid control system of claim 1, wherein the plurality of programming software tools comprises at least one of analysis tools, communication tools and controller logic development tools.

3. The programmable microgrid control system of claim 1, wherein the one or more microgrid assets comprise at least one of Distributed Generations (DGs), loads and Energy Storage Systems (ESSs).

4. The programmable microgrid control system of claim 1, wherein the microgrid power system is at least one of AC, DC and hybrid microgrid.

5. The programmable microgrid control system of claim 1, wherein the plurality of programming software tools comprises at least one of graphical user interface and script-based development environment.

6. The programmable microgrid control system of claim 5, wherein the script-based development environment is based on a software development framework for power system applications where an engineer accesses each power system element including at least one of settings, connectivity information, inputs, and outputs.

7. The programmable microgrid control system of claim 1, wherein the plurality of programming software tools employs real-time data to tune the model of the microgrid power system to simulate real-time situation.

8. The programmable microgrid control system of claim 6, wherein the inputs and outputs are recorded in a file during the performance analysis for further testing and debugging.

9. The programmable microgrid control system of claim 8 further comprises a tester program configured to play back the recorded inputs.

10. The programmable microgrid control system of claim 1, wherein the programmable microgrid controller is further configured to request analyses from the programming software tools to make control decision.

11. The programmable microgrid control system of claim 1, wherein the controller logic is encrypted.

12. A computer-implemented method for modeling, analyzing and monitoring a microgrid power system, comprising:
a processor comprising a plurality of programming software tools configured to:
generate a model of the microgrid power system,
analyze performance of the model of the microgrid power system,
generate a controller logic based on the model of the microgrid power system,
transmit the controller logic to the programmable microgrid controller device, and
monitor the microgrid power system; and
wherein the programmable microgrid controller is configured to execute the controller logic, and communicate with one or more microgrid assets.

13. The computer-implemented method of claim 12, wherein the plurality of programming software tools comprises at least one of analysis tools, communication tools and controller logic development tools.

14. The computer-implemented method of claim 12, wherein the one or more microgrid assets comprise at least one of Distributed Generations (DGs), loads and Energy Storage Systems (ESSs).

15. The computer-implemented method of claim 12, wherein the microgrid power system is at least one of AC, DC and hybrid microgrid.

16. The computer-implemented method of claim 12, wherein the plurality of programming software tools comprises at least one of graphical user interface and script-based development environment.

17. The computer-implemented method of claim 16, wherein the script-based development environment is based on a software development framework for power system applications where an engineer accesses each power system element including at least one of settings, connectivity information, inputs, and outputs.

18. The computer-implemented method of claim 12, wherein the plurality of programming software tools employs real-time data to tune the model of the microgrid power system to simulate real-time situation.

19. The computer-implemented method of claim 17, wherein the inputs and outputs are recorded in a file during the performance analysis for further testing and debugging.

20. The computer-implemented method of claim 19 further comprises a tester program configured to play back the recorded inputs.
